(19) United States
(12) Patent Application Publication
(10) Pub. No.: US 2011/0134366 A1
(43) Pub. Date: Jun. 9, 2011

(54) Backlight Module and Display Device Having the Same

(75) Inventors: Chih-Liang Pan, Hsin-Chu (TW); Yu-Yu Chen, Hsin-Chu (TW); You-Ming Wang, Hsin-Chu (TW); Yu-Hsiu Chang, Hsin-Chu (TW)

(73) Assignee: AU OPTRONICS CORPORATION, Hsin-Chu (TW)

(21) Appl. No.: 12/959,521

(22) Filed: Dec. 3, 2010

(30) Foreign Application Priority Data
Dec. 4, 2009 (TW) 098141622

(51) Int. Cl. G02F 1/1335; F21V 7/22

(52) U.S. Cl. 349/64; 362/607

(57) ABSTRACT

The present invention discloses a backlight module and a display device comprising the backlight module. The backlight module includes a light source, a light guide plate and a frame, wherein the light guide plate has a light entrance end and a first side. An angle is included between the light entrance end and the first side, wherein a plurality of light diffusing structures are formed on the light entrance end. The light source is disposed at a position corresponding to the light entrance end and emits a light toward the light diffusing structures. The frame has a first wall facing an inner surface of the first side. A centre line perpendicular to the light entrance end is defined on the light guide plate, wherein the distance between the inner surface and the centre line increases in a direction toward the light source.

### BACKGROUND OF THE INVENTION

1. Field of the Invention

This invention relates to a backlight module and a display device, specifically to an edge lighting backlight module and a display device comprising the edge lighting backlight module.

2. Description of the Prior Art

Display panels and planar display devices using display panels are now the mainstream amongst various types of display device. Liquid crystal display panels are now very popular amongst planar display devices and are used extensively in electronic products such as various display screens, flat televisions, planar monitors for personal computers and laptop computers as well as display screens in mobile phones and digital cameras.

Backlight module is a key element of the conventional liquid crystal display panels. The liquid crystal does not generate light by itself and the backlight module is used to provide adequate and evenly distributed light for the liquid crystal display panel to display images normally.

FIG. 1 and FIG. 2 are a top view and a cross-sectional view of a conventional backlight module, wherein a display panel 80 is disposed above the conventional backlight module 10. The conventional backlight module 10 includes a plurality of light sources 20, a frame 30, and a light guide plate 40. As FIG. 1 and FIG. 2 show, the frame 30 includes a side wall 32 and a bottom plane 33, wherein the side wall 32 encloses at least part of the bottom plane 33. The light guide plate 40 is disposed on the bottom plane 33 and at least partly enclosed by the side wall 32. Furthermore, as FIG. 2 shows, a reflector 70 is disposed between the light guide plate 40 and the bottom plane 33 for reflecting light emitted from the light guide plate 40 back to the light guide plate 40. The light source 20 is disposed at one side of the light guide plate 40 and emits light toward the light guide plate 40, wherein the light will be reflected and refracted and eventually leaves the light guide plate 40. As FIG. 2 shows, in order to adjust the uniformity or other characteristics of the light and transform the light into dispersed light, optical film sets such as prisms lens 50 and diffusion plate 60 are disposed on the light guide plate 40 to accept and process light from the light guide plate 40.

As FIG. 2 shows, the conventional backlight module 10 is coupled with a display panel 80 to provide the display panel 80 with adequate light to display images. As FIG. 1 shows, an active area 90 indicated by a dotted line is defined on the light guide plate 40, wherein the active area 90 is the effective area of the images displayed by the display panel 80. Furthermore, as FIG. 1 and FIG. 2 show, light A emitted from the lateral side of the light guide plate 40 impinges on the inner surface of the side wall 32. The side wall 32 is reflective and therefore light A will be reflected toward the edge of the light guide plate 40. In other words, after the conventional backlight module 10 and the display panel 80 are assembled, part of light A reflected by the side wall 32 will concentrate at the edge of the active area 90 to form a visible light strip. Please refer to both FIG. 1 and FIG. 2, it is easier for light A to be emitted from the light guide plate 40 near the light source 20 and to be reflected by the side wall 32. In this way, most of the light reflected by the side wall 32 near the light source 20 will concentrate at the edge of the active area 90 which intensifies the light leakage at the light strip.

The above-mentioned light strip will adversely affect the overall quality of displayed images and impair user's visual experience. Therefore, reducing the light leakage of the light strip is now an important issue for improving quality of displayed images.

### SUMMARY OF THE INVENTION

It is an object of the present invention to provide a backlight module and a display device comprising the backlight module which can reduce the light strip at the edge of the displayed images.

The backlight module of the present invention includes a light source, a light guide plate, and a frame, wherein the light guide plate is disposed on the frame and surrounded by the frame. The light guide plate includes a light entrance end and a first side, wherein the light source is disposed at the light entrance end of the light guide plate and emits light toward the light entrance end. A plurality of light diffusing structures are formed on the light entrance end for accepting light and breaking light into a more evenly distributed light. The frame includes a first wall corresponding to the first side of the light guide plate, wherein a gap exists between the first wall and the first side.

A centre line perpendicular to the light guide plate is defined on the light guide plate, wherein the centre line is preferably a straight line. The first wall has an inner surface facing the first side, wherein the distance between the inner surface and the centre line increases as the inner surface extends toward the light source. In other words, the first wall sinks toward the outer surface of the frame while extending toward the light source.

### BRIEF DESCRIPTION OF THE DRAWINGS

FIG. 1 and FIG. 2 are a top view and a cross-sectional view of a conventional backlight module;

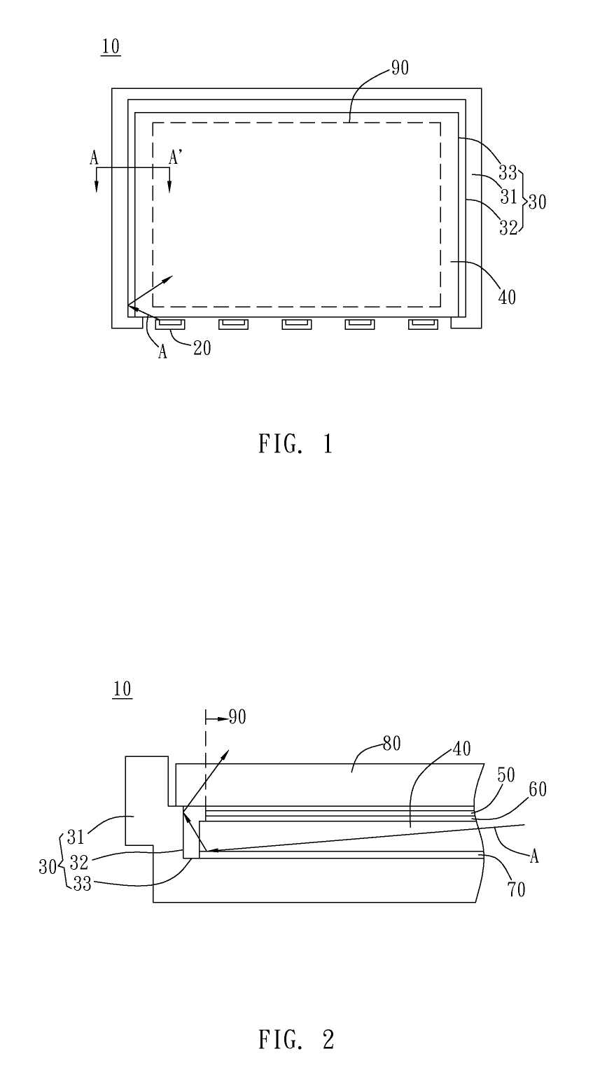

FIG. 3 is a top view of the backlight module of the present invention;

FIG. 4A and FIG. 4B are cross-sectional views of different contours of the backlight module illustrated in FIG. 3;

FIG. 5A and FIG. 5B are a top view and a cross-sectional view of the backlight module in one variation embodiment;

FIG. 6 illustrates a variation embodiment of the backlight module of FIG. 3;

FIG. 7A and FIG. 7B are respectively a top view and a cross-sectional view of the backlight module in another variation embodiment;

FIG. 8 illustrates yet another embodiment of the backlight module of the present invention;

FIG. 9A and FIG. 9B are cross-sectional views of different sections of the backlight module illustrated in FIG. 8;

FIG. 10 and FIG. 11 illustrate another variation embodiment of the backlight module; and

FIG. 12A and FIG. 12B are cross-sectional views of the display device of the present invention.

### DETAILED DESCRIPTION OF THE PREFERRED EMBODIMENT

The present invention discloses a backlight module and a display device including the backlight module, specifically to an edge lighting backlight module and a display device including the edge lighting backlight module. The present invention reduces the light leakage of light strip at the edge of the active area by modifying the inner structure and shape of the backlight module frame.

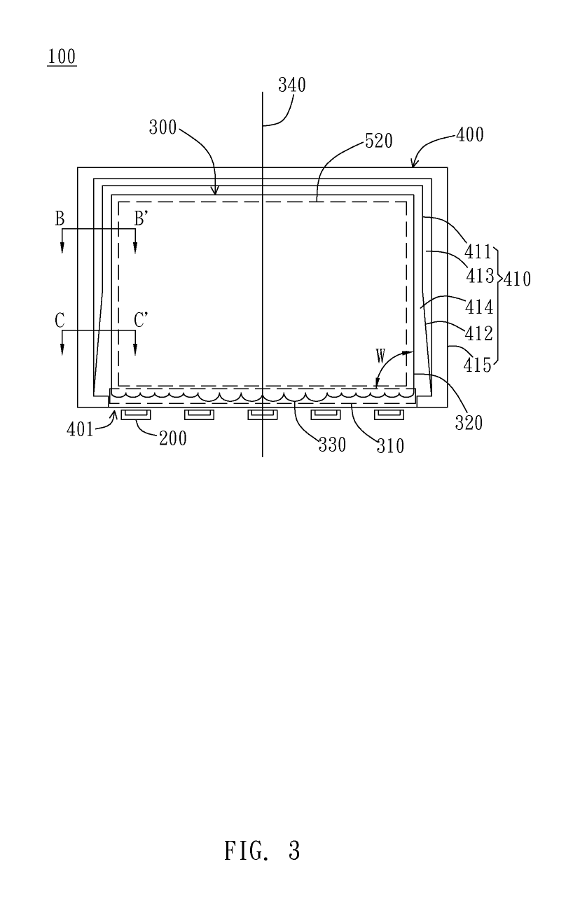

FIG. 3 is a top view of the backlight module of the present invention, wherein the backlight module includes light sources 200, a light guide plate 300 and a frame 400. In the present embodiment, the light source 200 includes a plurality of light emitting diodes disposed at one side of the frame 400, but is not limited thereto; in different embodiments, the light source 200 can include cold cathode fluorescent lamp or other suitable light emitting devices. The light guide plate 300 of the present embodiment includes a light entrance end 310 and a first side 320 adjacent to the light entrance end 310, wherein an angle W is included between the light entrance end 310 and the first side 320. In the present embodiment, the angle W between the light entrance end 310 and the first side 320 is substantially 90°, but is not limited thereto. In different embodiments, the angle W can be adjusted according to the size of the light guide plate 300, the distance between the first side 320 and the light source 200, or other design choices. Furthermore, a plurality of light diffusing structures 330 are formed on the light entrance end 310 to accept and harmonize the light emitted by the light source 200. As FIG. 3 shows, the light diffusing structures 330 are hemispheric convex lenses, but are not limited thereto; in different embodiments, the light diffusing structures 330 can include semi ellipsoidal convex lens or other convex lens having curved surfaces. Furthermore, as FIG. 3 shows, the light diffusing structures 330 at different locations have different sizes. In the present embodiment, the size of the light diffusing structure 330 is directly proportional to the refraction angle of the accepted light. Bigger light diffusing structure 330 can diffuse light from the light source 200 to the first wall 410 which then reflects the light back to the light guide plate 300 to create light leakage. Therefore, in the present embodiment, the light diffusing structures near the first side 320 are smaller than the light diffusing structures 330 close to the centre of the light guide plate 300, but are not limited thereto; in different embodiments, the light diffusing structures can have a uniform size.

In the embodiment illustrated in FIG. 3, the frame 400 is made of reflective material such as polycarbonate. The frame 400 includes a first wall 410, wherein the first wall 410 includes an inner surface 411, an inclined surface 412, and a top surface 413. The top surface 413 illustrated in FIG. 3 is a flange surface protruding from the first wall 410 for a display panel (not illustrated) to be disposed on the top surface 413. In the present embodiment, the inner surface 411 and the inclined surface 412 are lateral surfaces of the above-mentioned flange. The inner surface 411 and the inclined surface 412 are connected and substantially face the lateral side of the light guide plate 300, wherein the inclined surface 412 extends from the inner surface 411 toward the light source 200 and the light entrance end 310 and accordingly, the inclined surface 412 is close to the light source 200 and the light entrance end 310 than the inner surface 411 is. As FIG. 3 shows, there exists a fixed distance between the inner surface 411 and the light guide plate 300. In the present embodiment, the distance between the inner surface 411 and the light guide plate 300 is kept at 0.5 mm, but is not limited thereto; in different embodiments, the distance between the inner surface 411 and the light guide plate 300 can be adjusted based on the size of the light guide plate 300, the size of frame 400 or other design choices. Furthermore, in the present embodiment, the inner surface 411 and the inclined surface 412 are planes having smooth surfaces, but are not limited thereto; in different embodiments, microstructures with curved surface or sawteeth can be formed on the inner surface 411 and the inclined surface 412.

In the embodiment illustrated in FIG. 3, a centre line 340 is defined on the light guide plate 300 and perpendicular to the extending direction of the light entrance end 310, but is not limited thereto. The backlight module 100 illustrated in FIG. 3 is symmetrical, wherein the centre line 430 of the present embodiment is the axis of symmetry of the backlight module 100. In other words, in the present embodiment, the portion of frame 400 opposite to the first wall 410 also has the same inner surface 411, inclined surface 412 and the top surface 413 as the first wall 410, but is not limited thereto. That is, the backlight module 100 of the present invention can be asymmetrical. As FIG. 3 shows, the inclined surface 412 sinks toward an outer surface 415 of the frame 400 while extending toward the light source 200. In other words, the inclined surface 412 tilts away from the center line 340 in the direction toward the light source 200. Furthermore, the inclined surface 412 tilts from one end of the inner surface 411 at an angle of 5°, but is not limited thereto; in different embodiments, the inclined surface 412 can tilt at other angles based on the size of the light guide plate 300 and that of the frame 400.

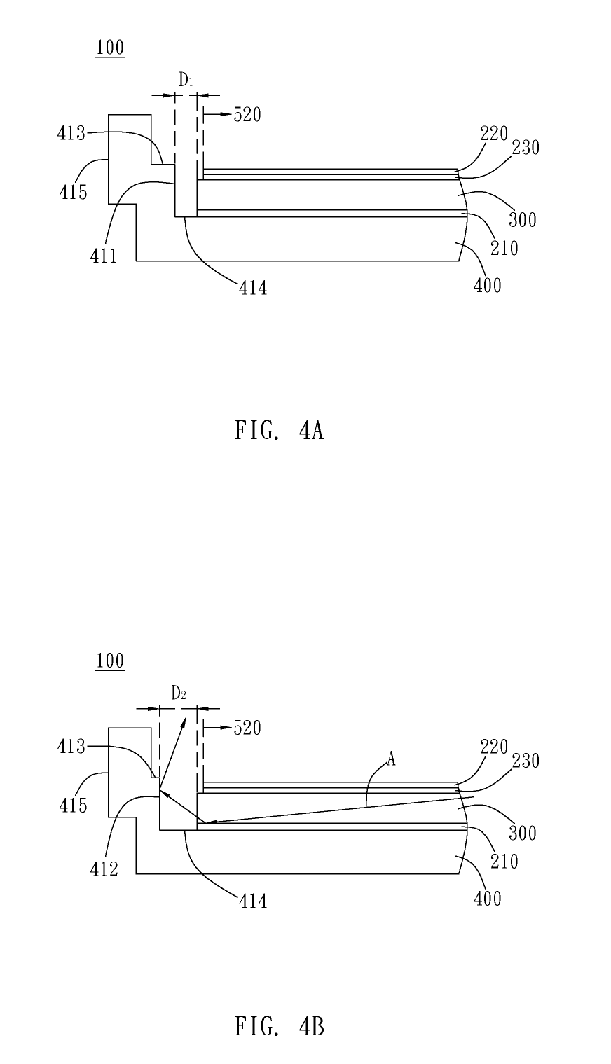

FIG. 4A and FIG. 4B are cross-sectional views of different sections of the backlight module 100 illustrated in FIG. 3, wherein FIG. 4A and FIG. 4B respectively illustrate sections along lines B-B′ and C-C′ in FIG. 3. As FIG. 4A and FIG. 4B show, a gap D₁ exists between the light guide plate 300 and the inner surface 411 and a gap D₂ exists between the light guide plate 300 and the inclined surface 412. The inclined surface 412 sinks toward the outer surface 415 of the frame 400 while extending toward the light source 200 and thus the D₂ is greater than the gap D₁. As FIG. 4A shows, the display panel 500 is disposed on the top surface 413 so that the display panel 500 can be disposed within the frame 400. However, as FIG. 3 and FIG. 4B show, as the inclined surface 412 sinks toward the outer surface 415, the area of the top surface 413 also shrinks while extending toward the light source 200. Therefore, the portion of top surface 413 of the first wall 410 near the light source 200 may not be able to support the display panel 500. In other words, the portions of display panel 500 near the light source 200 will be suspended in the air. As FIG. 4A and FIG. 4B show, the inner surface 411 of the present invention is a plane surface, but is not limited thereto; in different embodiments, the inner surface 411 can curvedly or zigzaggedly sink toward the outer surface 415. Furthermore, microstructures such as sawteeth can be formed on the inner surface 411.

Please refer to the backlight module 100 illustrated in FIG. 3 and FIG. 4B. As FIG. 3 shows, the area defined by the dotted line is the active area 520 of a display panel, wherein the active area 520 represents the maximum display area can be viewed by users, after the backlight module 100 is assembled with the display panel into a planar display device. In the embodiment illustrated in FIG. 3 and FIG. 4B, the inclined surface 412 tilts away from the centre line 340 and toward the outer surface 415 of the first wall 410 while extending toward the light source 200. Therefore, the gap D₂ between the inclined surface 412 and the light guide plate 300 increases with the inclined surface 412 tilting away from the centre line 340. In this way, even if light A emitted from the light guide plate 300 is reflected by the inclined surface 412, light A will emit away from the active area 520. Therefore, the light strip effect created by light A at the active area 520 can be reduced.

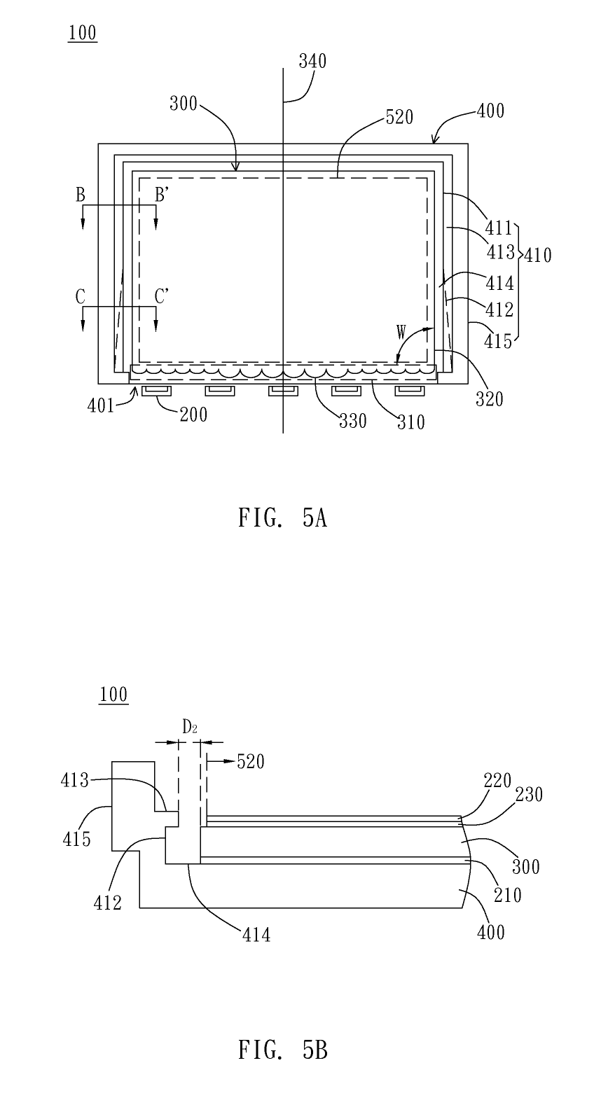

FIG. 5A and FIG. 5B are a top view and a cross-sectional view of the backlight module 100 in one variation embodiment, wherein FIG. 5B illustrates the cross-section C-C′ in FIG. 5A. As FIG. 5A and FIG. 5B show, the inclined surface 412 is located between the top surface 413 and a bottom plane 414, wherein the inclined surface 412 sinks away from the centre line 340 and toward the backside of the light guide plate 300, i.e. the inclined surface 412 can be regarded as a surface sinking from the top surface 413 toward the outer surface 415. Furthermore, the inclined surface 412 of the backlight module 400 tilts toward the outer surface 415 of the frame 400 while extending toward the light source 200. However, the inclined surface 412 is not connected to the top surface 413 and thus the edge of the top surface 413 will not tilt together with the inclined surface 412.

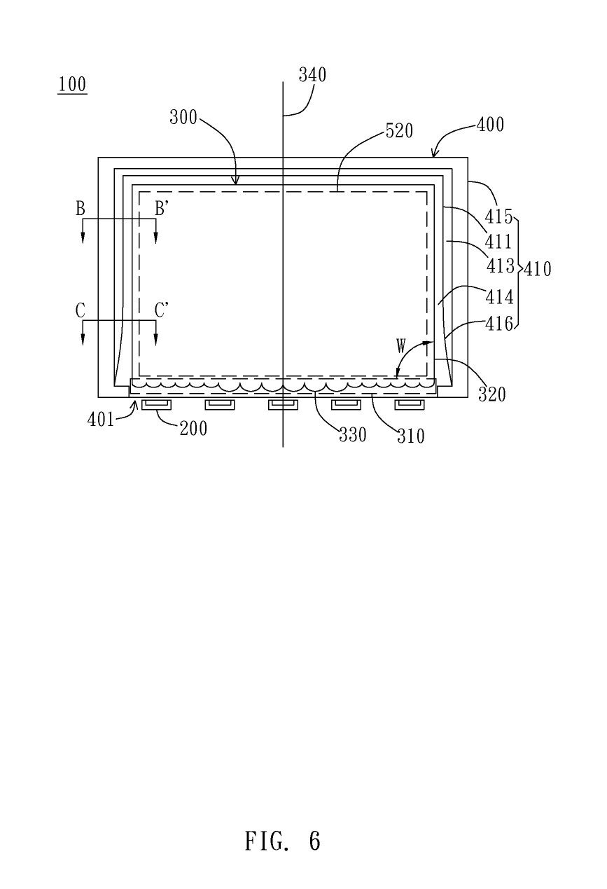

FIG. 6 illustrates a variation embodiment of the backlight module 100 of FIG. 3. In the present embodiment, the first wall 410 includes an inner surface 411 and a curve surface 416, wherein the curve surface 416 extends toward the light source 200 while curving away from the centre line 340 and toward the backside of the light guide plate 300. In other words, the curve surface 416 has the curvature of an oval, but is not limited thereto; in different embodiments, the curvature of the curve surface 416 can be adjusted to be circular or parabola based on the distance between the light guide plate 300 and the first wall 410, distance between the first wall 410 and the light source 200, or other design choices. Furthermore, as FIG. 6 shows, the curve surface 416 is a surface protruding toward the light guide plate 300; in different embodiments, the curve surface 416 can be a curve surface sinking toward the outer surface 415. Other than the curve surface 416 of the first wall 410, the backlight module of FIG. 6 is substantially identical to the one illustrated in FIG. 3 and thus will not be elaborated hereafter.

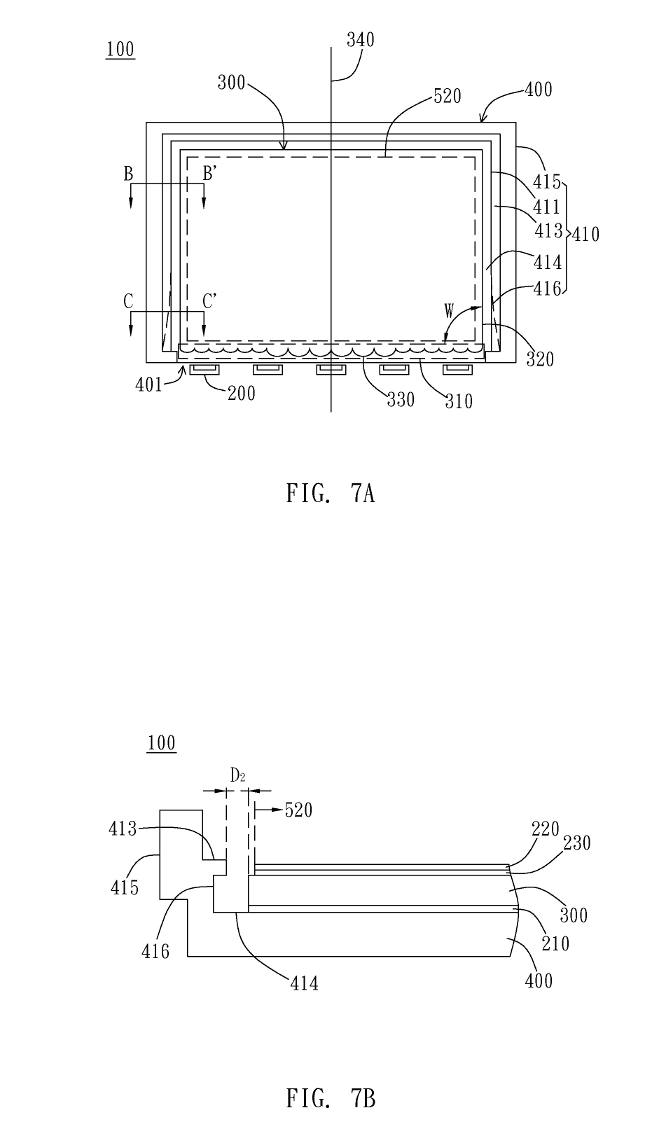

FIG. 7A and FIG. 7B are respectively a top view and a cross-sectional view of the backlight module 100 in another variation embodiment, wherein FIG. 7B illustrates the cross-section C-C′ in FIG. 7A. As FIG. 7A and FIG. 7B show, the curve surface 416 is located between the top surface 413 and the bottom surface 414. The curve surface 416 sinks away from the centre line 340 and toward the bottom surface 414, i.e. the curve surface 416 can be regarded as a surface sinking from the top surface 413 toward the backside of the light guide plate 300. Furthermore, while extending toward the light source 200, the curve surface 416 of the backlight module 100 also curves away from the centre line 340. However, in the present embodiment, the curve surface 416 is not connected to the top surface 413 and thus the edge of the top surface 413 will not tilt toward the outer surface 415 together with the curve surface 416.

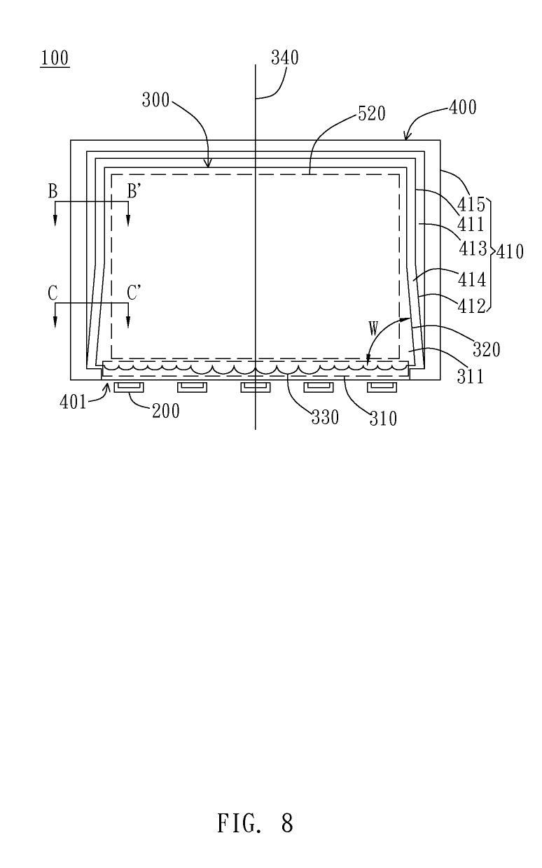

FIG. 8 illustrates yet another embodiment of the backlight module of the present invention. In the present embodiment, protrusions 311 are formed at two shorter sides of the light guide plate 300, wherein the protrusion 311 is connected between the first side 320 and the light entrance end 310. In the present embodiment, the distance between the inner surface 411 and the first side 320 is substantially equal to the distance between inclined surface 412 and the protrusion 311, but is not limited thereto; in different embodiments, the distance between the inclined surface 412 and the protrusion 311 can be adjusted based on the length and the width of the protrusion 311. In the present embodiment, light diffusing structure 330 is not formed on the protrusion 311. In other words, the light diffusing structures 330 are disposed only on the light entrance end 310, but is not limited thereto; in different embodiments, the light diffusing structures 330 can be selectively disposed on portions of the protrusion 311. Furthermore, in the present embodiment, the portion of protrusion 311 facing the inclined surface 412 is a plane surface, but is not limited thereto; the protrusion 311 can include a curve surface or a surface of different forms.

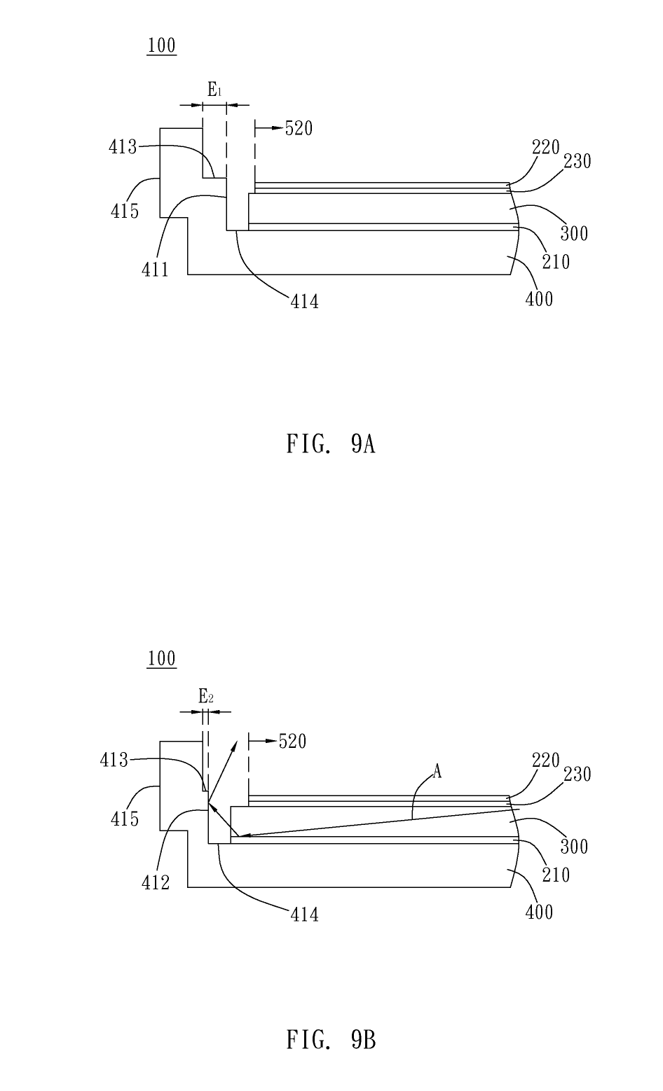

FIG. 9A and FIG. 9B are cross-sectional views of sections B-B′ and C-C′ of the backlight module illustrated in FIG. 8. In the embodiment illustrated in FIG. 9A and FIG. 9B, the inclined surface 412 and the light guide plate 300 extends toward the outer surface 415 at the same ratio. Therefore, the distance between the light guide plate 300 and the inner surface 411 and that between the light guide plate 300 and the inclined surface 412 are substantially the same. When light A is emitted from the light guide plate 300 and impinges on the inclined surface 412, light A will be reflected by the inclined surface 412 and directed over the light guide plate 300. The distance between the inclined surface 412 and the active area 520 is greater than that between the inner surface 411 and the active area 520. Therefore, the reflected light A will be further away from the active area 520 and the light strip will not occur at the active area 520. In other words, the inclined surface 412 can reduce the light leakage of the light strip at the edge of the active area 520. Furthermore, the top surface 413 in FIG. 9A and FIG. 9B have different width E₁ and E₂. The inclined surface 412 sinks toward the outer surface 415 while extending toward the light source 200 and therefore the top surface 413 also sinks toward the outer surface 415. In this way, the width E₂ corresponding to the inclined surface 412 is smaller than the width E₁ corresponding to the inner surface 411. Furthermore, the top surface 413 is used to accommodate the display panel such as liquid crystal display panel and therefore the area of the top surface 413 corresponding to the inclined surface 412 for supporting the display panel will shrink while the inclined surface 412 is extending toward the light source 200.

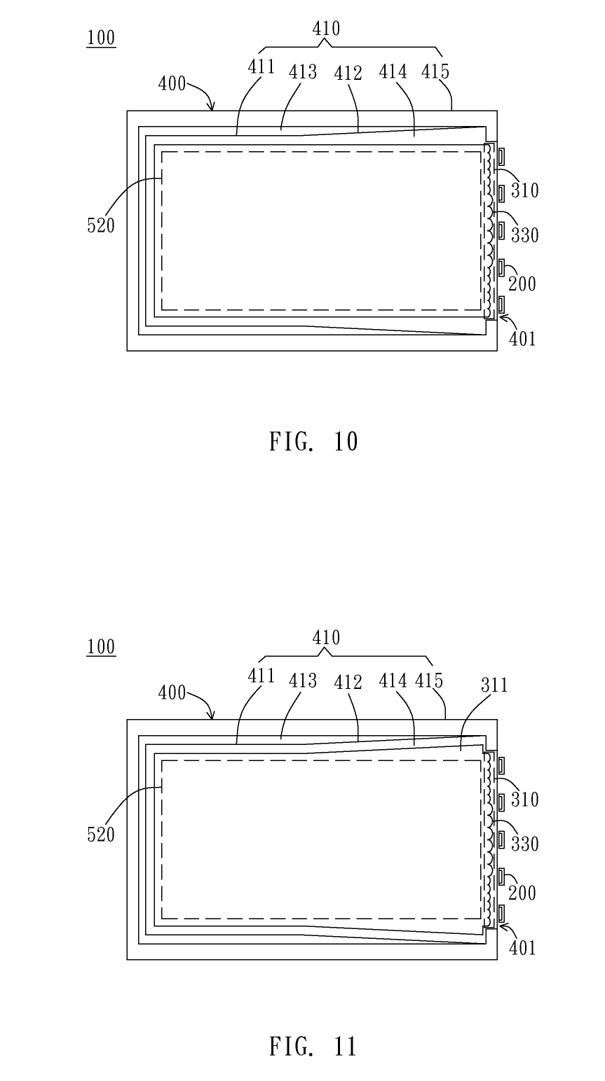

FIG. 10 and FIG. 11 illustrate another variation embodiment of the backlight module 100. In the embodiment illustrated in FIG. 10 and FIG. 11, the light entrance end 320 and a light entrance opening 401 are formed at the shorter sides of the light guide plate 300 and the frame 400. In other words, the light diffusing structures 330 are formed at the shorter side of the light guide plate 300 while the light sources 200 are disposed near the light entrance opening 401. In the present embodiment, the first wall 410 is the longer side of the frame 400. Furthermore, the light guide plate 300 does not include protrusion. However, in the embodiment illustrated in FIG. 11, protrusions 311 are formed at the longer sides of the light guide plate 300 and protrude toward the inclined surface 412, wherein the portion of protrusion 311 connected to the light entrance end 320 is disposed with light diffusing structures 330, but is not limited.

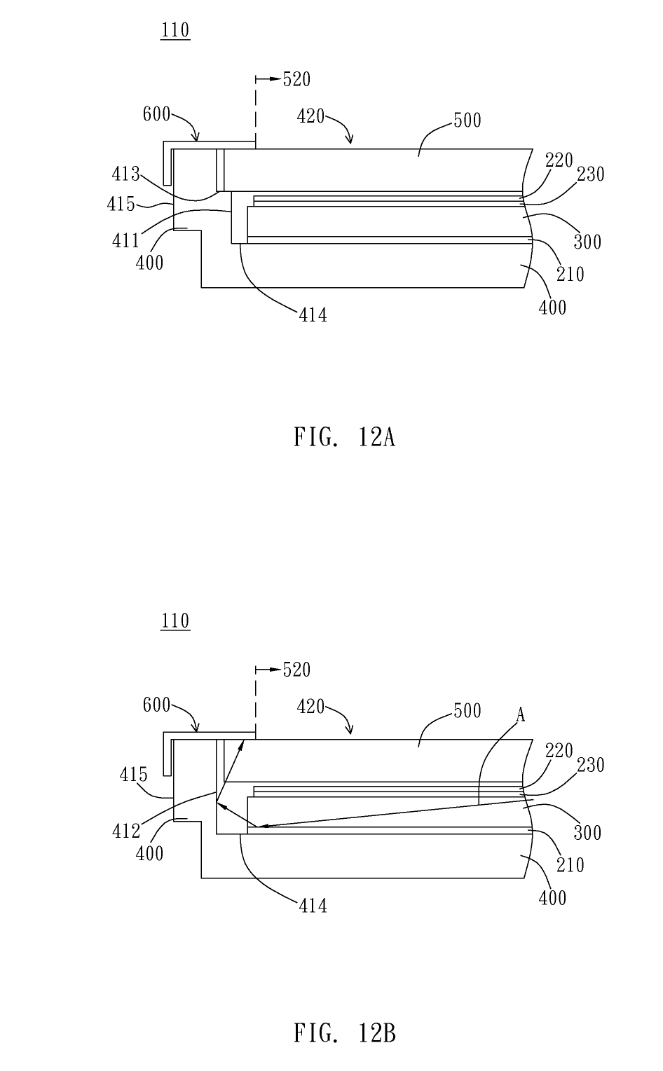

FIG. 12A and FIG. 12B are cross-sectional views of the display device 110 of the present invention, wherein the display device 110 in FIG. 12A and FIG. 12B further includes a casing 600. As FIG. 12A and FIG. 12B show, the display panel 500 is disposed on the frame 400 and substantially covers the light guide plate 300 to accept light emitted from the light guide plate 300 and displays images according images signals. Furthermore, the casing 600 substantially covers a portion of the display panel 500 and exposes a portion of the display panel 500 through a casing opening of casing 600. In the display device 110 in FIG. 12A and FIG. 12B, a dotted line defines the scope of the casing opening 420 and the active area 520 of the display panel 500, wherein the active area 520 is the portion of the display panel 500 exposed through the casing opening 420. In other words, the active area 520 illustrated in FIG. 12A and FIG. 12B defines the maximum visible area which can be viewed.

In the embodiment illustrated in FIG. 12A and FIG. 12B, a portion of the display panel 500 is located on the top surface 413 of the frame 400. In other words, the display device 110 uses the top surface 413 to position the display panel 500 within the space enclosed by the frame 400. Other than the display panel 500 being disposed, the structure of the display device 110 of the present embodiment is substantially the same as the backlight module 100 in FIG. 4A and FIG. 4B and thus will not be further elaborated here. Furthermore, as FIG. 12B shows, light A emitted from the light guide plate 300 will be reflected by the inclined surface 412 toward the display panel 500. The inclined surface 412 sinks toward the outer surface 415 of the frame 400 and therefore the distance between the inclined surface 412 and the light guide plate 300 is greater than that between the inner surface 411 and the light guide plate 300. In this way, due to the increase in distance between the inclined surface 412 and the light guide plate 300, light reflected at the inclined surface 412 is directed toward the casing 600 instead of the casing opening 420 or the edge of the active area 520. In other words, by increasing the distance between the inclined surface 412 and the light guide plate 300, the display device 110 can reduce the concentration of light at the edge of the active area 520 and the light leakage caused by light strip.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A backlight module, comprising:
a light source;
a light guide plate having a light entrance end and a first side, an angle being included between the light entrance end and the first side, a plurality of light diffusing structures being formed on the light entrance end, a centre line perpendicular to the light entrance end being defined on the light guide plate, wherein the light entrance end corresponds to the light source, the light diffusing structures accept light generated by the light source; and
a frame surrounding the light guide plate and including a first wall corresponding to the first side;
wherein the first wall has an inner surface facing the first side, a distance between the inner surface and the centre line increases in a direction toward the light source.

2. The backlight module of claim 1, wherein the inner surface includes an inclined surface extending toward the light source, the inclined surface tilts away from the centre line in the direction toward the light source.

3. The backlight module of claim 2, wherein the inclined surface sinks away from the centre line in a direction toward a backside of the light guide plate.

4. The backlight module of claim 2, wherein the inclined surface tilts at an angle less than 5°.

5. The backlight module of claim 1, wherein a curve surface is formed on the portion of the inner surface near the light source, the curve surface curves away from the centre line in the direction toward the light source.

6. The backlight module of claim 5, wherein the curve surface sinks away from the centre line in a direction toward a backside of the light guide plate.

7. The backlight module of claim 1, where a distance between the inner surface of the first wall and the first side of the light guide plate increases in the direction toward the light source.

8. The backlight module of claim 1, wherein the first side of the light guide plate inclines outward in the direction toward the light source so that a distance between the inner surface of the first wall and the first side is substantially constant.

9. The backlight module of claim 8, wherein the light guide plate includes a protrusion portion protruding outward from the light entrance end corresponding to the incline of the first side, and none of the light diffusing structures is disposed on the protrusion portion.

10. The backlight source of claim 1, wherein the light diffusing structure near the first side is smaller than the light diffusing structure near the centre line.

11. The backlight module of claim 1, wherein the frame is made of a reflective material.

12. A display device, comprising:
a display panel having a light entrance surface and a display area; and
a backlight module disposed corresponding to the light entrance surface of the display panel, including:
a light source;
a light guide plate having a light entrance end and a first side, an angle being included between the light entrance end and the first side, a plurality of light diffusing structures being formed on the light entrance end, wherein the light entrance end corresponds to the light source, the light diffusing structures accept light generated by the light source; and
a frame surrounding the light guide plate and including a first wall corresponding to the first side, the first wall includes a top surface supporting the display panel on a portion outside the display area;
wherein the first wall has an inner surface facing the first side, a distance between the inner surface and the display area increases in a direction toward the light source.

13. The display device of claim 12, wherein the inner surface includes an inclined surface near the light source, the inclined surface tilts away from the display area in the direction toward the light source.

14. The display device of claim 13, wherein the inclined surface is connected to the top surface, an edge of the top surface shrinks as the inclined surface tilts away from the display area.

15. The display device of claim 13, wherein the inclined surface sinks away from the display area in a direction toward a backside of the light guide plate.

16. The display device of claim 13, wherein the inclined surface tilts at an angle less than 5°.

17. The display device of claim 12, wherein a curve surface is formed on the portion of the inner surface near the light source, the curve surface curves away from the display area.

18. The display device of claim 17, wherein the curve surface is connected to the top surface, an edge of the top surface shrinks as the curve surface curves away from the display area.

19. The display device of claim 17, wherein the curve surface sinks away from the display area in a direction toward a backside of the light guide plate.

20. The display device of claim 12, wherein a distance between the inner surface of the first wall and the first side of the light guide plate increases in the direction toward the light source.

21. The display device of claim 12, wherein the first side of the light guide plate protrudes outward in the direction toward the light source, so that a distance between the inner surface of the first wall and the first side of the light guide plate is substantially constant.

22. The display device of claim 21, wherein the light guide plate includes a protrusion portion protruding outward from the light entrance corresponding to the incline of the first side, and none of the light diffusing structures is disposed on the protrusion portion.

23. The display device of claim 12, wherein the light diffusing structure near the first side is smaller than the light diffusing structure near a middle of the light entrance end.

24. The display device of claim 12, wherein the frame is made of a reflective material.
